(19) United States
(12) Patent Application Publication
(10) Pub. No.: US 2004/0098611 A1
(43) Pub. Date: May 20, 2004

(54) Optimizing retrieval of requested data from a remote device

(76) Inventors: Timothy E. Bean, Pleasanton, CA (US); Gary Carter, Morgan Hill, CA (US); Aloke Bordia, Santa Clara, CA (US)

Correspondence Address: ERIC L. MASCHOFF, WORKMAN NYDEGGER, 1000 Eagle Gate Tower, 60 East South Temple, Salt Lake City, UT, 84111, US

(21) Appl. No.: 10/703,046

(22) Filed: Nov. 6, 2003

Related U.S. Application Data
(60) Provisional application No. 60/424,480, filed on Nov. 6, 2002.

(51) Int. Cl. G06F 11/30

(52) U.S. Cl. 713/200

(57) ABSTRACT

Analyzing data on a network. Data captured on a network may be analyzed. Network traffic is captured during a period of time where the network traffic is captured as raw data into logical blocks. Capturing is done at a network monitoring computer. Data points are compiled. The data points include an offset defining a number of bytes into the captured data and datum headers including the number of frames in the logical block, the number of bytes in the logical block, and clock ticks since the initiation of capturing. At a user computer remote from the network monitoring computer, a user is presented with a graphical user interface representation of the network traffic by graphing byte density over time in a capture histogram.

### CROSS REFERENCE TO RELATED APPLICATIONS

This application claims the benefit of U.S. Provisional Application No. 60/424,480 filed Nov. 6, 2002, which is incorporated herein in its entirety.

### BACKGROUND OF THE INVENTION

1. The Field of the Invention

The invention generally relates to the field of troubleshooting high-speed data networks. More specifically, the invention relates to methods and apparatus for minimizing the amount of data that needs to be transported over a network to a remote user computer to effectively troubleshoot the high-speed network.

2. Description of the Related Art

Modern computer networks involve the transmission of large amounts of data at very high speeds across the networks. For example, in some networks, transmission rates as high as 10 Gbits/second are currently being used, and hardware and protocols that will support up to 40 Gbits/second are now being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period.

Collecting all of the data into a capture enables a network administrators to perform a detailed analysis on the collected data. However, recording network traffic that travels at such high transmission rates may result in very large captures. In fact, the resources used to process and view captures may be inadequate. For example, a 10 Gbits/second network can generate a 60 Gigabyte (GB) file in less than a minute. To perform a detailed analysis of the network data in a 60 GB capture, the 60 GB capture must be opened and analyzed on the network administrator's computer. Directly opening such a large file using a typical computer can take hours due to the data processing required to make the network data presentable to the network administrator. Additionally, such large captures require significant memory resources, the use of which can be burdensome to a computer system.

Another challenge arises when a user in one location needs to troubleshoot data collected in another location. For example, if a user in Los Angeles had the need to troubleshoot network problems in New York, there may be a problem getting the collected network data to the Los Angeles user for analysis, because the analysis of high-speed networks typically requires the processing of large amounts of captured data, which cannot be quickly or easily transmitted to remote locations. Commonly, the captured data is streamed to the local user's computer in the background while the user analyses the data sequentially as it arrives. This may be less desirable in some situations when data of particular interest exists at some significant time into the data. In such a case, the user must wait for data that is of less interest to be downloaded before data of particular interest can be received

Further, the user's computer is often limited in the amount of resources available to open such large files, causing the process of opening and processing the captured data to be very slow. Processing very large captures can take hours, which represents an unacceptable delay when a user has a large capture to investigate.

### BRIEF SUMMARY OF THE INVENTION

One embodiment of the invention includes a method of analyzing network traffic stored at a network monitoring computer. The network traffic has been captured into logical blocks. The logical blocks may be stored in a capture. The capture includes a header (including information related to all of the captured network traffic) a histogram data storage (including data points for graphing the network traffic) and captured data storage (for storing the captured network traffic into logical blocks). The method includes receiving data points at a user computer remote from the network monitoring computer. The data points are useful for defining information about the logical blocks. The data points include an offset defining a number of bytes into the captured network traffic. The data points further include datum headers including the number of frames in a logical block, a number of bytes in a logical block, and clock ticks since the initiation of capturing. The method further includes presenting the user with a graphical user interface representation of the network traffic by representing information contained in the data points and graphing byte density over time in a capture histogram.

Another embodiment of the invention includes a method for displaying captured network traffic previously captured as raw data into logical blocks. The method may be practiced on a computer system that has a graphical user interface. The method includes receiving data points from a remote computer. The data points include an offset defining a number of bytes into the captured raw data. The data points further include datum headers including the number of frames in a logical block, the number of bytes in the logical block, and clock ticks since the initiation of capturing. The method further includes presenting the user with a graphical user interface representation in the form of a histogram of the network traffic using the data points by graphing byte density over time.

Still another embodiment of the invention includes a method of accessing captured network traffic stored on a network monitoring computer. The network traffic may have been captured during a period of time and stored on a network monitoring computer in logical blocks. The method includes accessing data points at a computer remote from the network monitoring computer. The data points are useful for defining information about the logical blocks. The data points include an offset defining a number of bytes into the captured network traffic. The data points further include datum headers including the number of frames in a logical block, number of bytes in the logical block, and clock ticks since the initiation of capturing. The method further includes selecting a portion of the captured network traffic based on information contained in the data points. The method also includes causing a portion of the captured network traffic from the network monitoring computer to be downloaded.

One embodiment of the invention reduces the amount of captured network traffic that must be transmitted to a user for analysis by allowing the user to select portions of the network traffic for viewing. Advantageously, a user is presented with a histogram representation of captured network traffic existing a location remote from the user from which the user can select network traffic for viewing.

These and other advantages and features of the present invention will become more fully apparent from the following description and appended claims or may be learned by the practice of the invention as set forth hereinafter.

### BRIEF DESCRIPTION OF THE DRAWINGS

In order that the manner in which the advantages and features of the invention are obtained, a more particular description of the invention will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a typical network topology on which the invention may be deployed;

FIG. 2 illustrates the organization of an exemplary capture;

FIG. 3 illustrates one embodiment of a graphical user interface displaying graphically a description of the contents of a capture; and

FIG. 4 illustrates an embodiment where a local user computer is connected through a network to a remote network monitoring computer that captures data traffic.

### DETAILED DESCRIPTION OF THE INVENTION

In order to resolve problems that may exist on a network, it is often necessary to analyze the network data traffic. This is achieved by storing network data in captures. As previously described, however, captures can become large in short periods of time because of data transmission rates. As a result, users such as network administrators may have to store, retrieve, process, and view large amounts of data. Embodiments of the present invention relate to systems and methods for storing, retrieving, and displaying data including captures. Advantageously, embodiments of the present invention can reduce the amount of data that is processed, thereby improving the ability to resolve network problems.

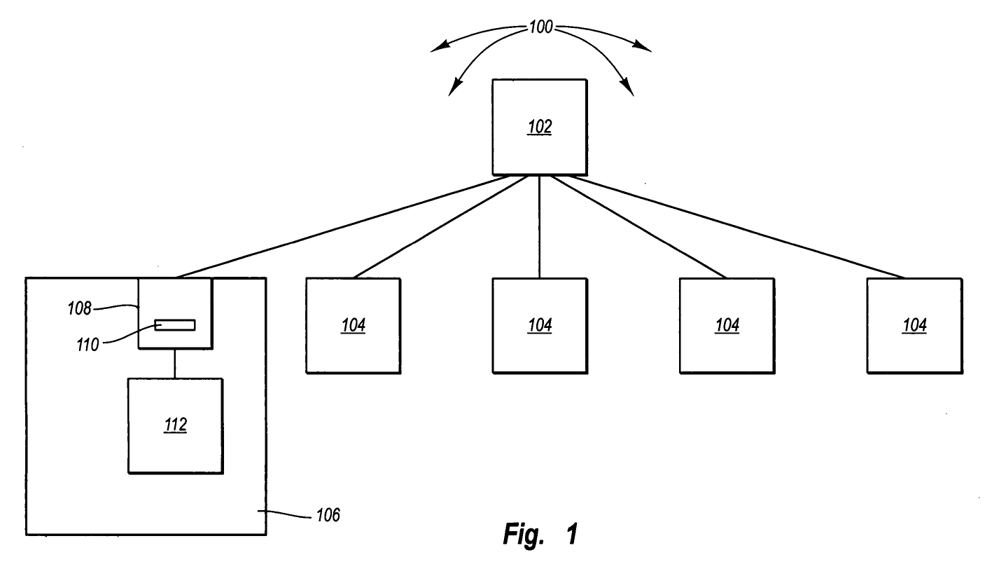

Referring now to FIG. 1, a general overview of the data capture operation of one embodiment of the invention is shown. FIG. 1 shows one network topology 100 on which the present invention may be used although one of skill in the art can appreciate that a network may include, but is not limited to, Local Area Networks, Wide Area Networks, the Internet, and the like or any combination thereof. The network topology 100 may also be either a wired and/or wireless network. In this example, a network switch or router 102 controls the flow of network data to client computers 104. A network monitoring computer 106 is used by the network administrator to detect and solve transmission problems existing on the network. The network monitoring computer 106 has a capture device 108 that captures and processes or analyzes all of the network traffic during, for example, selected periods of time.

To initiate the analysis process and to troubleshoot transmission problems existing on the network, the network monitoring computer 106 performs a capture operation to collect data on the network. During the capture operation, data is streamed from the interface (e.g. a network adapter card) of the capture device 108 to a memory buffer 110 on the capture device 108. The data is captured as raw data into data blocks. The sizes of the captured data blocks do not necessarily correspond to packet size. In this embodiment, each of the packets in the data blocks is marked with a counter value, indicating the number of clock ticks since the capture was started.

When data is collected, the data blocks are often streamed from the memory buffer 110 on the capture device 108 to a disk or other mass storage 112 that is external with respect to the capture device 108 and has more storage capacity. The process of physically storing the data to the mass storage 112 is governed by the technology of the software and hardware provided by the disk manufacturer. For example, the data is often stored in 512-byte sectors on the mass storage 112.

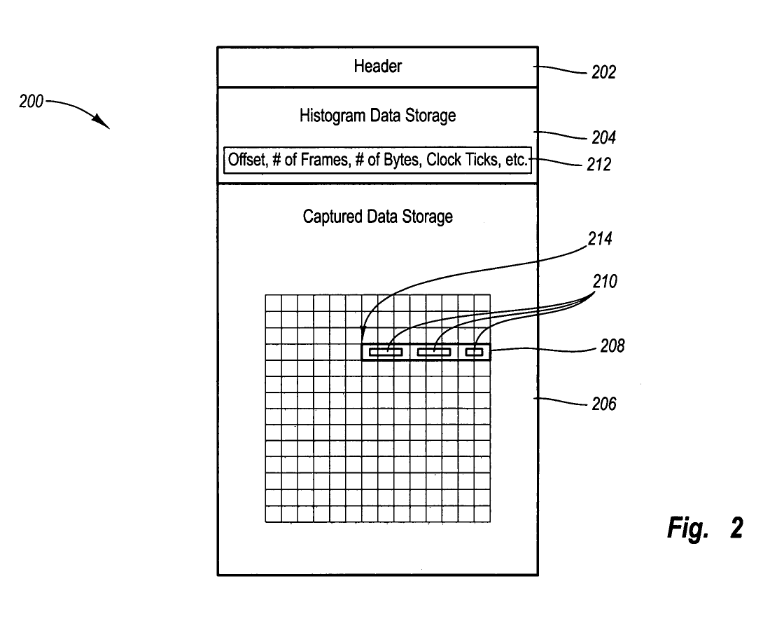

In one embodiment, the network administrator is able to retrieve and analyze the captured data in an order that can be determined by the network administrator. In other words, the network administrator is not limited to retrieving the captured data in a sequential manner. This is achieved, in one embodiment, by organizing the captured raw data into logical blocks that are referred to herein and shown in FIG. 2 as datums 208. In one embodiment, each logical block corresponds to a datum 208. A datum 208 may include one or more physical sectors on the mass storage 112 or storage device on which the datum 208 is stored and may contain one or more frames 210 of data from the network. Each datum 208 has a corresponding datum header that describes information concerning the datum 208. The information described in a particular datum header may include the number of frames (or packets) captured in the corresponding datum 208, the number of bytes contained in the frames 210 and a count of the clock ticks since the initiation of the capture operation in which the data in the particular datum 208 was captured.

During the capture operation, a set of data points 212 are stored at various offsets or numbers of bytes into the captured data. A data point 212 includes an offset of the first frame of a datum in the mass storage 112 and the datum header information corresponding to the data point 212. This information is recorded as part of a capture such as the capture shown in FIG. 2 and designated generally as 200. The offset of each data point is recorded to create a compilation of the datum header records. as the raw data is written to the mass storage 112. Once the capture operation is complete and the raw data is written to the mass storage 112, the data points and each of their respective datum headers are also written to the disk in the histogram data storage area 204 of the new capture 200.

According to one embodiment of the invention, the newly created capture stored on disk or other suitable medium, is logically divided into three parts, including a capture header 202, the aforementioned histogram data storage 204 and captured data storage 206. The capture header 202 contains information related to the entire capture. This information may include a magic or parity string used to verify the validity of the data on the mass storage 112, the capture device 108 speed when the capture occurs, the starting time and stopping time of the capture, the number of frames captured to memory buffer 110 on the capture device 108, the number of frames stored from memory buffer 110 onto the mass storage 1112, whether the captured data is sliced or truncated, and the length of the slice or truncation of the data, if applicable.

The histogram data storage 204 may contain the offset and datum header for each datum in the captured data. Captured data storage 206 contains the captured data frames 210 in the form of raw data. Each frame 210 may have a packet header, packet data and optional padding. The capture 200 continues to fill with raw data until the mass storage 112 is full or the network administrator stops the capture process.

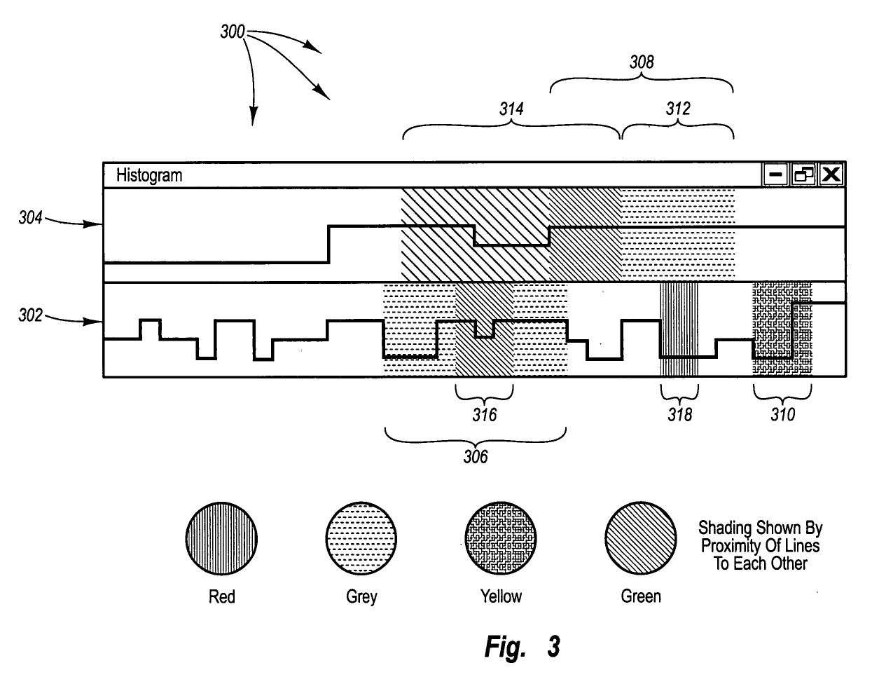

From the capture header 202 information and histogram data storage 204, a graphical user interface (GUI) representation of the capture data can be generated by graphing byte density over time in a histogram, such as is shown in FIG. 3 by the GUI designated generally as 300. The information needed to display the graph of GUI 300 is smaller than the full volume of the captured data. Thus, the information associated with GUI 300 can be transmitted to a computer used by the network administrator in a short amount of time, whether the network administrator is located locally or remotely with respect to the capture device 108 or the mass storage 112. The GUI 300 presents a summarized view of parameters or characteristics of the captured data and enables the network administrator to make an informed decision. The GUI 300, for example, helps identify a subset, or segment, of the captured data that is to be processed and displayed in more detail, as described in greater detail below.

To enable the network administrator to select a capture segment of the captured data for further analysis, the GUI presents a histogram to a network administrator as described above. In this example, a portion of the histogram is represented in a data selection window 308 of FIG. 3, which highlights a segment of the histogram that graphically represents selected parameters or characteristics of the captured data. The operation of data selection window 308 and its relationship with other portions of GUI will be described in greater detail below. The width of the data selection window 308 can be adjusted to increase or reduce the size of the capture segment selected by the network administrator. When a capture segment is selected in the histogram, the selected capture segment coordinates defined by the corresponding highlighted segment of the histogram are translated into beginning and end location addresses in the capture data storage 206 section of the capture 200 on mass storage 112 or another storage device using the data points in the histogram data storage area 204 of the capture 200. An analysis engine associated with the capture device 108 then formats only the raw data that begins with the beginning location address and ends with the end location address for display and calculates packet timestamp values from the stored clock tick counts. The segment is then passed to the GUI application 300 for protocol decoding and display.

In this manner, network administrators can navigate through large amounts of captured data without the need processing the full volume of captured data and/or transmit the full volume of captured data from the capture device to a computer that is used to display analysis information to the network administrator. As shown in FIG. 3, the initial data transmitted to the computer associated with the network administrator is represented graphically by two interdependent graphs or histograms. The capture histogram 302 may represent the entire captured data set. Within this capture histogram 302 is a zoom window 306 that the network administrator can drag for navigation to highlight a segment of the capture histogram 302. The width of the zoom window 306 in the capture histogram 302 is defined to encapsulate a subset, such as 10% of the bytes of the entire volume of captured data. For example, if there are 256 GB of captured data, the zoom window 306 on the capture histogram 302, in this example, represents 25.6 GB of data. Once the zoom window 306 is positioned and released in the capture histogram 302, a zoom histogram 304 graphically represents the span of data highlighted and defined by the zoom window 306 in the capture histogram 302.

After the segment is selected using the capture histogram 302 as described above, the corresponding frames are obtained, decoded, and displayed using the capture viewer. The network administrator can move or dock the GUI 300, with its histograms, to any location on the screen or hide them altogether. FIG. 3 shows an undocked zoom histogram 304 and capture histogram 302. Each histogram in this example is arranged with time along the horizontal axis and bytes along the vertical axis. The zoom histogram 304 is a slave to the capture histogram 302. The zoom histogram 304 serves for fine-tune navigation and additional zooming functionality. A data selection window 308 in the zoom histogram 304 can be used to select portions of the captured data for viewing by the network administrator. The width of the data selection window 308 on the zoom histogram 304 is not predefined, but is user configurable. The width may be determined to be equal to a number of bytes as defined by the network administrator.

The zoom histogram 304 has the ability to zoom out using a computer mouse via a Ctrl+left-double-click and a zoom-in via a left-double-click action or by any other suitable user input mechanism. The amount of zoom is network administrator defined with a default of 80%. For example, with an 80% zoom, a left-double-click in the zoom histogram window causes the middle 80 percent of the previous data to remain with 10 percent shaved off either end. A click-drag-release operation allows the network administrator to manually fine tune the data selection window 308 by selecting an edge and dragging it thereby increasing or decreasing the size of the data selection window 308 dynamically.

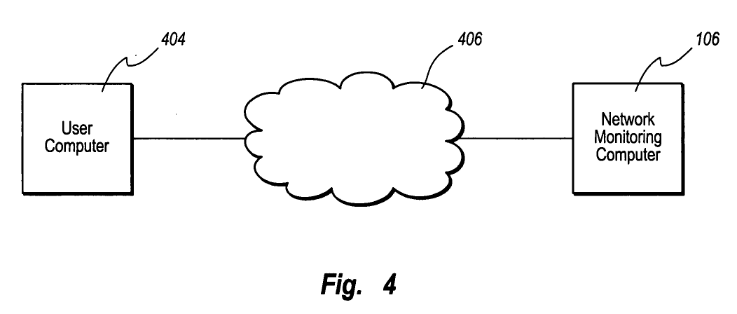

The captured data frames are often stored on a remote capture device or other remote storage medium and must be gathered to a local computer available to the network administrator for inspection and analysis. The distance between the captured data frames and a computer used for inspection and analysis can be across a building, city, etc. To solve network problems quickly and efficiently, it is useful to optimize the data sent to the local computer by only sending the most desirable portions of the captured data frames. Selected portions are transported through a network to the user computer operated by the network administrator as is shown in FIG. 4, which illustrates a user computer 404 connected through a network 406, such as the Internet or some other wide-area network, to a network monitoring computer 106. Notably, network 406 may be the same or a different network than the network for which data frames are captured. Data frames may be captured on a local area or private wide-area network, whereas network 406 may include the Internet or some other wide-area network. As discussed previously, to send the entire volume of captured data frames requires that huge amounts of data be transmitted from the network monitoring computer 106 to the user computer 404. Such a file transfer may be at best inconvenient considering that the transmission rates across the network 406. When the network 406 is a network such as the Internet, using connections such as those shown in FIG. 4 are often limited to 1.5 Mbits per second. In one embodiment, only segments of the captured data frames present on the network monitoring computer 106 are sent across the network 406 to the user computer 404.

To scale large amounts of captured data, a compression algorithm may be applied. For example, if 256 GB of data is captured and the granularity of data points represented in the graph is every 10 MB, the capture histogram 302 needs to display 25,600 data points. The 25,600 data points take too long to draw and are not functionally presentable. To solve this graphics problem, the compression algorithm is employed for cosmetic data improvement. The same compression algorithm may also be applied to the zoom histogram 304 when there is a large amount of data and a corresponding large number of data points.

Using the zoom window 306 that may be disposed on the user computer 404, the network administrator identifies the sections of the captured data storage 206 (stored locally or remotely) to process and analyze. The GUI 300 will then populate the zoom histogram 304 with a representation of the data from the selected segment in the capture histogram 302. The network administrator will further zoom the selected data in the zoom histogram 304 and select a portion using the data selection window 308. When data frames are captured and stored remotely, the data frames selected using the data selection window 308 are transported from the remote device such as the network monitoring computer 106 and stored temporarily on a local personal computer such as the user computer 404. For example, the data frames may be stored in a cache area on the user computer 404. The sections of the captured data frames that are processed and stored in the defined cache area or other storage location local to the user computer 404, are identified in the GUI 300 using color shading as depicted in FIG. 3. In this example the green areas 314 and 316 represent data frames that have been previously selected, stored on the user computer 404, processed, analyzed and are available for display and oz viewing on the user computer 404.

After making an initial selection, the network administrator may wish to 7° view another section of the capture 200 on the network monitoring computer 106. If the user computer 404 has already downloaded and stored in the cache area data frames that are a part of the new section of data requested, the existing data frames from the cache area may be used without the need to re-download those data frames. Therefore, only new data frames that are not already stored, or in other words, do not overlap with the data frames in the cache area locally are requested from the network monitoring computer 106. The new data frames may be merged with the data stored in the cache area.

For example, when a network administrator desires to view another section of the captured data as indicated in the data selection window 308, the user computer 404 may have already stored data frames 314 in the cache area that overlaps the newly selected data frames. In this case, a file structure in the cache area on the user computer 404 is used to determine which data frames from the new selection are already available on the user computer 404 in cache. Then, a request to receive only the new data frames, such as the data represented by the new data area 312 that is not already available in the cache area is issued to the network monitoring computer 106. Once the new data frames, represented in new data area 312, are sent by the network monitoring computer 106 and received at the user computer 404, the data frames stored in the cache area, i.e. the data represented by the green area 314, are merged with the new data, represented by the new data area 312. The combination of all the data frames represented by areas 314 and 312 on the user computer 404 is now available for display and analysis by the network administrator as described above. The data frames represented by area 312 will be shown as green when they arrive on the user computer 404 and the area 316 will expand to the right a small amount in the capture histogram 302 indicating the area of the capture and data frames that are now available on the user computer 404. One of skill in the art can appreciate that other indicators, coding, color schemes or graphical representations can be employed with a similar effect.

The amount of local storage in the cache area defined by the network administrator is limited with respect to the size of the captured data stored locally or remotely. When selecting portions of the data in the GUI 300 to process, data frames that have been stored locally may need to be removed to make room for currently selected data frames. Data frames that have been removed or overwritten from the cache area on the user computer 404 are indicated by shading portions of the GUI 300 a different color, such as in this example yellow, as shown in FIG. 3 in the area designated 310. This shading indicates unavailability of the data frames represented by that portion of the histogram. Further, there may exist situations when the captured data frames are neither available on the user computer 404 or the network monitoring computer 106. In such cases, the unavailability of the captured data frames may be indicated by a color code such as the red area 318 shown in FIG. 3.

When the total size of the captured data frames is less than the size of the available cache area, the network administrator may be prompted to save all the captured data frames represented by the GUI 300 to the local cache area. Alternatively, the network administrator may be prompted to save selected portions of the captured data frames defined by the network administrator using the GUI 300. When the volume of captured data frames is large, the network administrator is only able to save portions of the captured data frames.

In situations when the network administrator is not able to completely troubleshoot network problems in a single session, a data file may be saved on the user computer 404 for later use. When the user computer 404 opens the saved data file stored on the user computer 404 and is also actively connected to a network monitoring computer 106 with available captured data, one embodiment of the invention determines if the captured data frames stored on the network monitoring computer 106 are from the same capture operation as the captured data stored in the saved data file. This determination is done using timestamps in one embodiment. If the timestamps match, then a relationship is established between the saved data file and the captured data on the network monitoring computer 106. The network administrator is able to use the GUI 300 and the opened data file to re-navigate any unsaved portions of the captured data frames that continue to remain on the network monitoring computer 106. If the saved data file is not associated with the captured data frames on the network monitoring computer 106, a separate GUI 300 is opened in a separate window and is not associated with the network monitoring computer 106. The network administrator may continue to examine and troubleshoot data frames stored locally at the user computer 404.

Aspects of the present invention may be embodied in several forms. For instance, some aspects of the invention may be embodied using a digital computer such as those that are ubiquitously present. The digital computer may store software code useful for executing acts specified in embodiments of the invention. The digital computer may also embody certain aspects of systems in which manifestations of the invention are present. Further, aspects of the invention may be embodied in the form of a computer readable medium with instructions for performing acts specified in embodiments of the invention. Illustratively, but not exhaustively, such computer c: z readable medium may be floppy disks, CD or DVD media, tape drives, computer hard drives and the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which some within the meaning and range of equivalency of the claims are to be embraced within their scope.

What is claimed is:

1. A method of analyzing captured network traffic stored at a network monitoring computer, the method comprising:
at a user computer remote from the network monitoring computer, accessing a portion of a capture, the capture comprising:
a captured data storage including captured network traffic captured into logical blocks; and
a histogram data storage comprising data points corresponding to the captured network traffic; and
receiving data points that define information about the logical blocks, the data points including:
an offset defining a number of bytes into the captured network traffic; and
datum headers including the number of frames in a logical block, number of bytes in the logical block, and clock ticks since the initiation of capturing; and
presenting a user with a graphical user interface representation of the network traffic using information in the data points.

2. The method of claim 1, wherein presenting a user with a graphical user interface representation of the network traffic comprises graphing byte density over time in a capture histogram.

3. The method of claim 2, wherein presenting a user with a graphical user interface representation of the network traffic comprises:
including a zoom window, the zoom window useful for highlighting a segment of the capture histogram; and
representing the segment of the capture histogram in a zoom histogram.

4. The method of claim 3, further comprising:
including a data selection window for highlighting a segment of the zoom histogram;
receiving data frames corresponding to the highlighted segment of the zoom histogram; and
displaying data frames corresponding to the highlighted segment of the zoom histogram.

5. The method of claim 1, wherein presenting a user with a graphical user interface representation of the network traffic comprises applying a compression algorithm to the data points.

6. The method of claim 3, wherein representing the segment of the capture histogram in a zoom histogram comprises applying a compression algorithm to the data points.

7. The method of claim 3, further comprising coding portions of the capture histogram and the zoom histogram with a first indicator representing logical blocks that exist at the user computer.

8. The method of claim 3, further comprising coding portions of the capture histogram and the zoom histogram with a second indicator representing logical blocks that were previously stored at the user computer, but that are not presently stored at the user computer.

9. The method of claim 3, further comprising coding portions of the capture histogram and the zoom histogram with a third indicator representing logical blocks that are not stored at the user computer or at the network monitoring computer.

10. The method of claim 3, further comprising:
color coding portions of the capture histogram and the zoom histogram with a first color representing logical blocks that exist at the user computer;
color coding portions of the capture histogram and the zoom histogram with a second color representing logical blocks that were previously stored at the user computer, but that are not presently stored at the user computer; and
color coding portions of the capture histogram and the zoom histogram with a third color representing logical blocks that are not stored at the user computer or at the network monitoring computer.

11. The method of claim 4, further comprising:
downloading the frames corresponding to the highlighted segment of the zoom histogram across a packet switched network; and
storing the frames in a cache, wherein the cache is user definable.

12. The method of claim 9 wherein downloading comprises:
downloading new frames from the network monitoring computer that are not stored at the user computer;
merging the new frames with frames that were previously stored at the user computer.

13. The method of claim 4, further comprising saving a data file including the data frames for later use.

14. The method of claim 11, further comprising:
opening the data file;
determining if the frames are from the same capture operation as captured frames stored on the network monitoring computer using timestamps;
if the frames are from the same capture operation as captured frames stored on the network monitoring computer, establishing a relationship between the network monitoring computer and the user computer such that data frames existing on the network monitoring computer may be downloaded to the user computer.

15. A computer readable medium with instructions for performing the method of claim 1.

16. In a network analyzing system, a method of providing captured network traffic to a user, the method comprising:
(A) creating a capture, the capture comprising:
(1) a data storage area comprising the captured network traffic captured as raw data and organized into logical blocks;
(2) a histogram data storage comprising a plurality of data points, the data points comprising:
(a) an offset defining a number of bytes into the captured raw data; and
(b) datum headers including the number of frames in a logical block, number of bytes in the logical block, and clock ticks since the initiation of capturing; and
(B) sending the data points, the data points useful to present a graphical user interface representation in the form of a histogram of the network traffic by graphing byte density over time.

17. The method of claim 16, further comprising:
receiving a user selection of a portion of the histogram; and
sending data frames corresponding to the selected portion of the histogram.

18. The method of claim 16, creating a capture further comprising creating a capture header containing information related to all of the captured network traffic including at least one of a parity string, capture device speed, start and stop times of a capture, number of frames captured, number of frames stored on a mass storage, whether the captured data is sliced or truncated, and the length of the slice or truncation of the data, if applicable.

19. A method of accessing captured network traffic stored on a network monitoring computer, the network traffic having been captured during a period of time and stored on the network monitoring computer in logical blocks, the method comprising:
at a computer remote from the network monitoring computer, accessing data points the data points useful for defining information about the logical blocks, the data points including:
an offset defining a number of bytes into the captured network traffic; and
datum headers including the number of frames in a logical block, number of bytes in the logical block, and clock ticks since the initiation of capturing;
selecting a portion of the captured network traffic based on information contained in the data points; and
retrieving the portion of captured network traffic from the network monitoring computer.

20. The method of claim 19, wherein selecting comprises:
using a capture histogram and a zoom histogram, the capture histogram including a zoom window, the zoom window useful for highlighting a segment of the capture histogram and representing the segment of the capture histogram in a zoom histogram, the zoom histogram including a data selection window useful for highlighting a segment of the zoom histogram for selecting a portion of the captured network traffic.

21. The method of claim 19, further comprising:
storing the downloaded portion of the captured network traffic at the user computer in a cache wherein the cache is user definable.

22. The method of claim 19, further comprising saving a data file with the portion of the captured network traffic for later use.
